(19) United States
(12) Patent Application Publication
(10) Pub. No.: US 2015/0269614 A1
(43) Pub. Date: Sep. 24, 2015

(54) Combination Social Media Dashboard, Social Media Website Network and Monetized Advertisement Marketplace

(71) Applicant: Christopher J. Kramer, Kirkland, WA (US)

(72) Inventor: Christopher J. Kramer, Kirkland, WA (US)

(73) Assignee: ONENAME GLOBAL, INC., Kirkland, WA (US)

(21) Appl. No.: 14/661,290

(22) Filed: Mar. 18, 2015

Related U.S. Application Data
(60) Provisional application No. 61/954,651, filed on Mar. 18, 2014.

(51) Int. Cl. G06Q 30/02; G06Q 50/00

(52) U.S. Cl. CPC G06Q 30/0251; G06Q 30/0277; G06Q 50/01

(57) ABSTRACT

A combination social media dashboard aggregator, social media website network, and monetized advertisement marketplace. A private user account is synchronized with a plurality of social media accounts, wherein a news feed from each of the plurality of social media accounts is retrieved. The news feed for each of the plurality of social media accounts is then aggregated into an aggregate social feed, while a social tab is generated for the news feed of each of the plurality of social media accounts. Through the private user account, a user can also post social content to selected social media accounts. Distribution parameters can also be set for the social content, dictating the date and time the social content is to be posted. The user can choose a selected advertisement to be displayed on a homepage dashboard, profile, or group page of the social network. An advertisement input action monetizes the selected advertisement.

The current application claims a priority to the U.S. Provisional Patent application Ser. No. 61/954,651 filed on Mar. 18, 2014.

### FIELD OF THE INVENTION

The present invention relates generally to social networking websites. More specifically, the present invention is a combination social media aggregator, social network, and advertisement marketplace which is intended to provide users with a single feed of social information comprising various different information feeds from other social media websites allowing all users to consume, create, manage and share social media from a single social media, “dashboard hub” enabling each the ability to earn money doing what they already do.

### BACKGROUND OF THE INVENTION

The modern world has become more interconnected than ever before thanks to a myriad of different communications and networking technologies which enable seamless transfer of data from one side of the world to the other in a matter of mere seconds. This interconnectedness, thanks largely due to the creations of the internet, has enabled unprecedented exchange and communication of various different kinds of information. Human civilization has taken advantage of the connectivity offered by the internet to perform many different tasks involving the exchange of information between two or more parties. A few examples include the exchange of media like pictures and videos, the exchange of data files, for communication between individuals and organizations, and electronic transaction of sales. All of these uses for networks and communications technology have become an invaluable part of modern human civilization, and many would find the world to be a very unfamiliar place without them. One particular use of information exchange over the internet which has become increasingly popular is that of social media.

Social media can be defined as information pertaining to the current life of some individual which they would like to share with other individuals. This is performed on a social media website—a website or application that enables users to create and share content or to participate in social networking. Social media websites serve as a medium for the exchange of social information amongst an extremely wide range of users. They can be accessed by virtually anyone as they are hosted on the internet, and can therefore be used by anyone to distribute a wide variety of social media to groups of their friends.

Social media websites typically function by allowing a user to create an account which is complete with basic information about the user such that other users can identify them. The user is then free to compile a friends list of user's who they consider friends. These friends are typically privy to most, if not all, of the information pertaining to the user which is stored on the social media website. Typically, the user is able to make posts about virtually any subject they wish, and can even provide links to other websites or upload certain media items such as videos or pictures to the social media website. This information is often of interest to the user's friends who may therefore keep a close eye on a given social media website such that they are kept appraised of events in the user's life. Many social media websites make money by placing advertisements on various pages throughout the website.

Unfortunately, there is one particular issue to keep in mind in relation to the subject of social media; there are many different social media websites, all of which have separate websites and typically require user's to maintain an account in order to post and or view information posted by other users. It can become exceedingly tedious to either post or view social media when it is present on so many different social media websites. One particular technology which has recently emerged to enable more efficient and more pervasive exchange of information between users is known as a social media dashboard. A social media dashboard is a program or website that allows you to post, view, and manage many of your social account profiles in one place. Social media dashboards are known to aggregate social media account profiles for viewing and distribution, but have not been known to display advertisements.

An additional issue of current social media websites is the fact that their advertising systems fail to compensate their users for the content and time spent on the various social media web sites. Generally, all of these profits go directly to the social media website provider. Thus, if the user was offered a system whereby they can consolidate social media website streams to a dashboard that also included the social media website features, along with some incentive, whereby they could easily select advertisements to be displayed on their own account pages this would easily allow people to make money from content and time spent on social media websites they use all in one convenient place. There is currently no social media website, social media dashboard or advertising marketplace which solves all of the above issues, which is where a new utility is established.

It is resultantly an object of the present invention to introduce a combination social media dashboard, social media website, and advertisement marketplace that allows the end users to make money, which combines all of these concepts to create a new and extremely useful platform. The present invention is intended to provide aggregation of social media information feeds from a plurality of different sources to a single dashboard. The present invention combines all of the features of a social media website network together with a social dashboard. The present invention also allows a user to select specific advertisements which are then displayed on a homepage dashboard, profile and group pages; the user is compensated a preset amount of money every time a particular action results from that advertisement. Thus, the user is provided with incentive to select advertisements which have a higher chance of resulting in actions. The present invention allows for both the posting to and the viewing of aggregate information which is compiled from a plurality of different social media websites. Thus the present invention serves as a hub for a user to both make posts across many social media web sites, and for others users to view the posts which originate from various different social media websites.

The present invention allows for both media control and public viewing of the aggregated social information feed. This helps users to keep track of all social developments of those people who they are concerned with, without needing to visit a plurality of different social media websites. The present invention is also unique in that it layers on all of the features of a social media web site network with the social dashboard and then incorporates an advertisement marketplace which allows the user to choose advertisements to be displayed on the home dashboard, profile and group pages; the user is paid a certain amount of money for each action involving the website. Thus, the user is provided with incentive to choose advertisements to be displayed on these areas of the combined social media website network and social dashboard. Never before has an aggregated social dashboard been combined with a social network and advertisement marketplace that compensates the user, which is where the new utility is created.

### BRIEF DESCRIPTION OF THE DRAWINGS

FIG. 1 is a flowchart depicting the steps for aggregating a plurality of social media accounts within a private user account;

FIG. 2 is a flowchart thereof, further depicting steps for displaying a selected advertisement alongside an aggregate social feed;

FIG. 3 is a flowchart thereof, further depicting steps for crediting the private user account for an advertisement input action carried out by a public user;

FIG. 4 is a flowchart thereof, further depicting steps for receiving an advertisement bid from the public user;

FIG. 5 is a flowchart thereof, further depicting steps for adjusting the selected advertisement according to advertisement settings;

FIG. 6 is a flowchart thereof, further depicting steps for receiving login credentials to synch the plurality of social media accounts to the private user account;

FIG. 7 is a flowchart thereof, further depicting steps for retrieving privacy credentials and applying said privacy credentials to the aggregate social feed;

FIG. 8 is a flowchart thereof, further depicting steps for receiving distribution parameters to dictate the posting of social content;

FIG. 9 is a flowchart thereof, further depicting steps for retrieving a specific new feed from each of the plurality of social media accounts;

FIG. 10 is a flowchart thereof, further depicting steps for utilizing a filter selection to filter the content of the aggregate social feed; and

FIG. 11 is a flowchart thereof, further depicting steps for adjusting the frequency with which the aggregate social feed is updated.

### DETAIL DESCRIPTIONS OF THE INVENTION

All illustrations of the drawings are for the purpose of describing selected versions of the present invention and are not intended to limit the scope of the present invention.

The present invention is a combination social media dashboard, social network, and monetized advertisement marketplace. The present invention provides a method for combination social media aggregation, social media website network features and advertisement display through a website that is hosted on the internet through a server, or similar networking equipment. The website allows the present invention to be easily accessed by any user having a computer or other electronic device with an internet connection and a standard web browser application, or similar means. The website comprises an account information and login module, and a homepage dashboard for logging into and navigating about the website respectively.

The account information and login module enables a user to create a private user account through which the user is able to access functions of the website. The creation of the private user account is necessary as the user must provide relevant information to allow the present invention to receive information from other third party social media websites. The account information and login module also provides secure access to certain aspects of the present invention pertaining to the connection to the third party social media websites and the posting of content via the present invention. It is important that only authorized users are able to view and access these functions, thus the creation of the private user account. The account information and login module utilizes a unique username and password to allow only authorized users access to certain functions of the present invention through the private user account.

The user can create the private user account in one of two ways. The first way to create the private user account is by providing personal information, such as the full name of the user, an email address, and a date of birth. Once the personal information is submitted through the website by the private user, the server stores the personal information and generates the private user account. The server then sends a confirmation email to the email address provided by the user, wherein the user can then click a link, directing the user to a profile confirmation page. The second way to create the private user account is by providing login credentials for a third party social media website. Once the login credentials are provided, the server retrieves the necessary information from the third party social media website and generates the private user account.

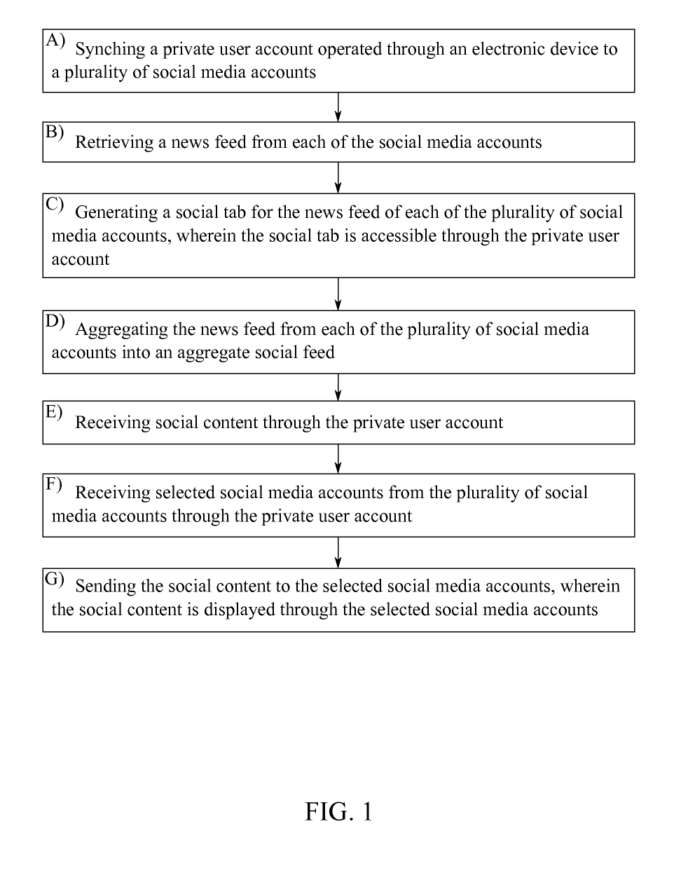

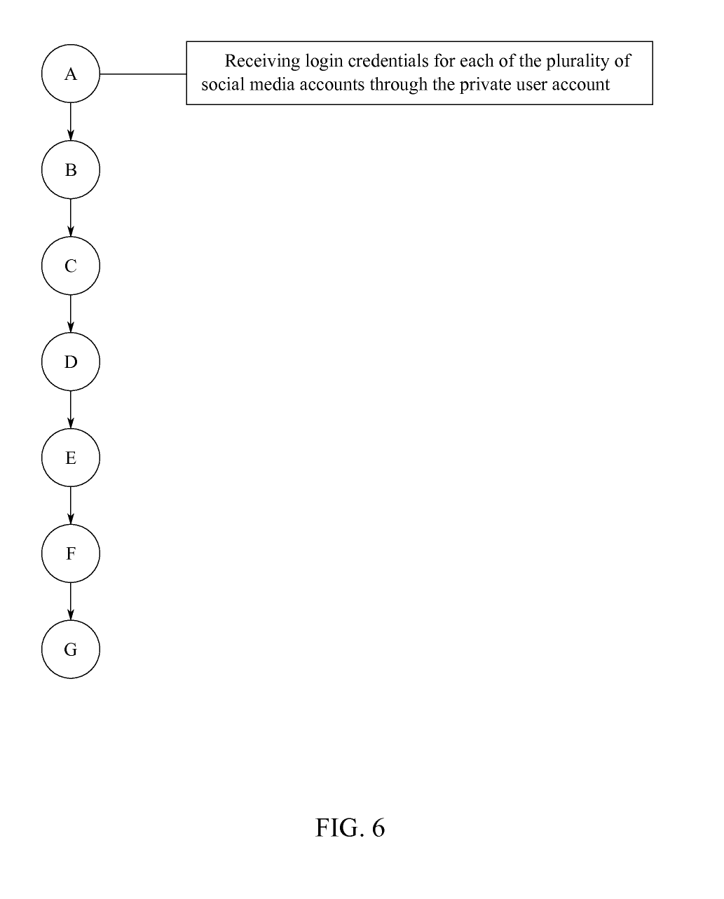

In reference to FIG. 1 and FIG. 6, through the private user account, the user is able to access functions of the homepage dashboard of the private user account by synchronizing a plurality of social media accounts with the private user account. The user selects the plurality of social media accounts that the user would like to synchronize and then submits the login credentials for each of the plurality of social media accounts through the private user account being operated on an electronic device. The electronic device is in communication with the server, wherein the server receives the login credentials for each of the plurality of social media accounts through the private user account. Upon receiving the login credentials, the server synchronizes the private user account with each of the plurality of social media accounts.

In reference to FIG. 1, the server then retrieves a news feed from each of the plurality of social media accounts; the news feed being a series of events, updates, pictures, statuses, etc. from friends of the user. The information is translated from the plurality of social media accounts to the private user account through the use of an application programming interface. Next, the server generates a social tab for the news feed of each of the plurality of social media accounts selected by the user, wherein the social tab is accessible through the homepage dashboard of the private user account. The user can then click the social tab for a specific social media account from the plurality of social media accounts in order to display the news feed for the specific social media account through the homepage dashboard of the private user account.

In further reference to FIG. 1, in addition to generating the social tab for each of the plurality of social media accounts, the server generates an aggregate social feed being a combination of information from each of the plurality of social media accounts. The server aggregates the news feed from each of the plurality of social media accounts into the single aggregated feed and then generates an aggregate tab. The aggregate tab is displayed on the homepage dashboard of the private user account alongside the social tab for each of the plurality of social media accounts. In this way, the user can view the news feed from each of the plurality of social media accounts in a single feed by clicking the aggregate tab.

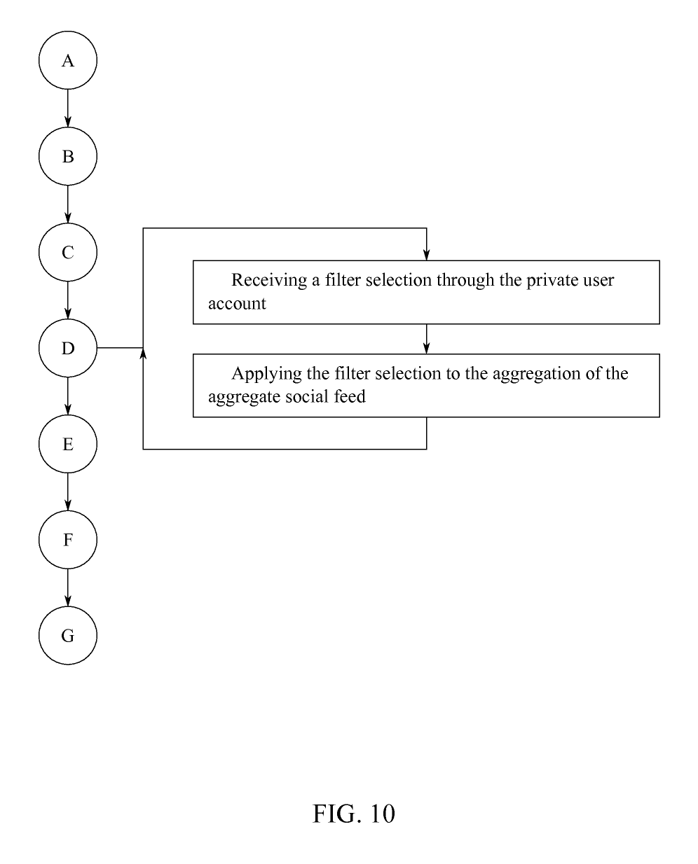

In reference to FIG. 10, while the aggregate social feed is designed to display all social information from the plurality of social media accounts, the user can choose to filter the aggregate social feed such that the aggregate social feed only displays the social information originating from selected social media websites. This allows the user to account for redundancies and improve the ease with which information found in the aggregate social feed is viewed and processed. In order to filter the aggregate social feed, the user submits a filter selection through the private user account. The server then receives the filter selection and applies the filter selection to the aggregation of the aggregated social feed.

Additionally, the filter selection may be used to change to whom the information in the aggregate social feed displayed through the homepage dashboard of the private user account is related. For example, the filter selection can be set to friends only, such that only information in regards to specific friends defined by the user is retrieved from the news feed of each of the plurality of social media accounts and aggregated into the aggregate social feed. As another example, the filter selection could be set to user only, wherein only posts made by the user (either pending or previously made) are retrieved from the news feed of each of the plurality of social media accounts and aggregated into the aggregate social feed.

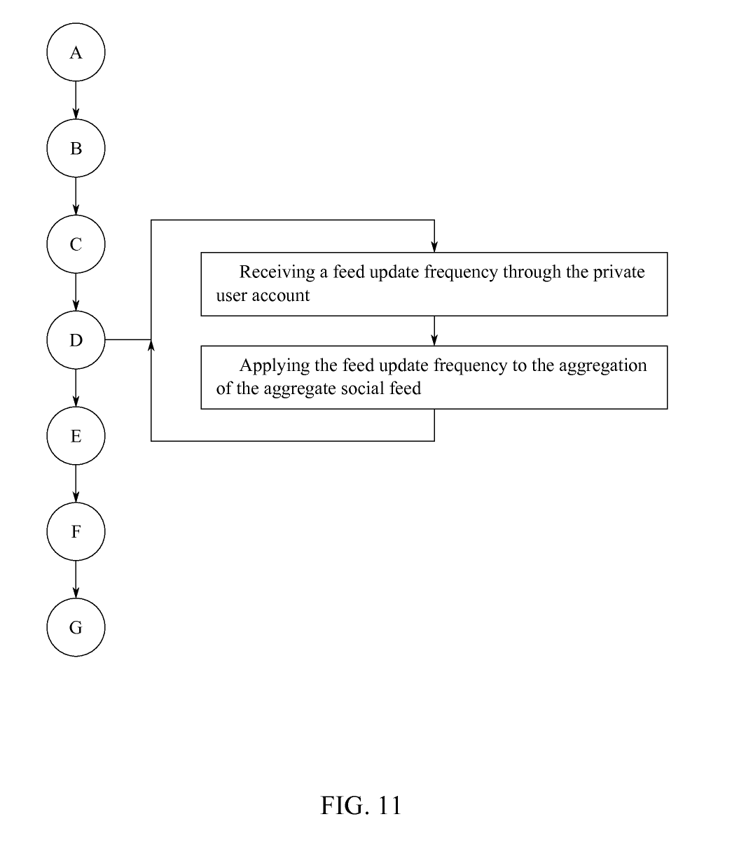

In reference to FIG. 11, in addition to filtering the information that is displayed through the aggregate social feed, the user can adjust the frequency with which the aggregate social feed is updated. The ability to change the frequency with which the aggregate social feed is updated can help prevent an overload of information from being displayed due to the sheer volume of social information coming from the plurality of social media accounts. In order to change the refresh rate for which information is aggregated and displayed, the user submits a feed update frequency through the private user account. The server then receives the feed update frequency and applies the feed update frequency to the aggregation of the aggregate social feed.

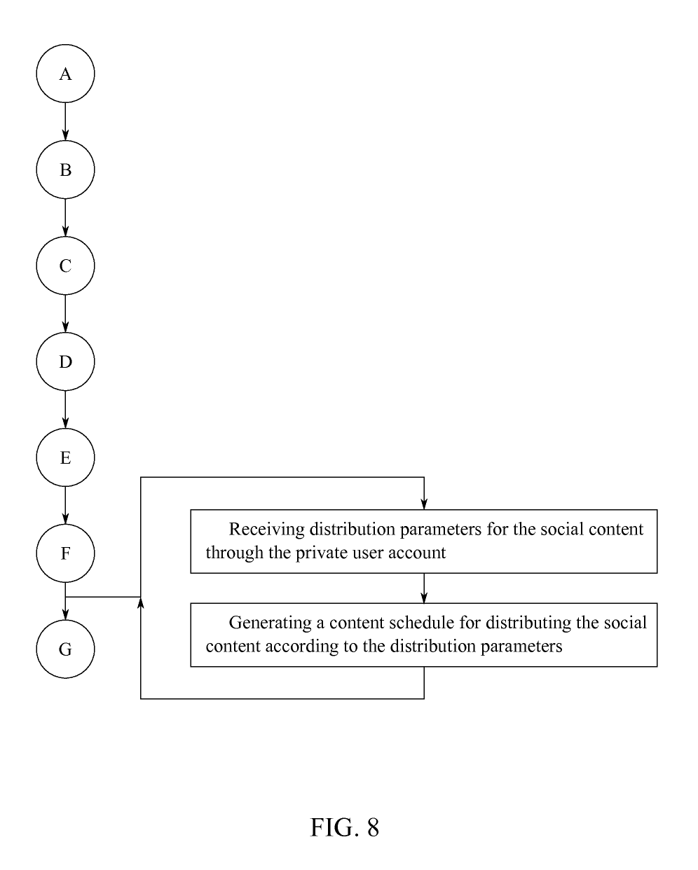

In reference to FIG. 1 and FIG. 8, the homepage dashboard of the private user account also allows the user to post social content to the plurality of social media accounts, in addition to viewing social feeds. A broadcast content scheduling module is provided by the present invention, wherein the user can enter the social content into the broadcast content scheduling module through the private user account. Using the broadcast content scheduling module, the user can also enter selected social media accounts from the plurality of social media accounts synchronized with the private user account to which the social content is to be posted. Furthermore, the user can define distribution parameters through the broadcast content scheduling module in regards to when the social content is to be posted.

In the preferred embodiment of the present invention, the broadcast content scheduling module provides an input field for submitting the social content in the form of text comments, hyperlinks, pictures, videos, etc. A social button is provided for each of the plurality of social media accounts, wherein the social button can be toggled on and off in order to dictate the selected social media accounts to which the social content is distributed. A calendar icon is provided that when selected opens input fields for selecting the date and time at which the social content is to be posted to the selected social media accounts.

In reference to FIG. 1 and FIG. 8, the server receives the social content through the broadcast content scheduling module, in addition to the selected social media accounts and the distribution parameters. Using the distribution parameters, the server generates a content schedule for distributing the social content according to the distribution parameters. The content schedule is saved, and is accessible to the user through the private user account, such that the user can view pending content to be posted and edit content before it is posted. The server then sends the social content to the selected social media accounts at the date and time dictated by the distribution parameters. The social content is then displayed through the selected social media accounts. In turn, the social content may then be retrieved again by the server as a part of the news feed of the selected social media accounts and integrated into the aggregate social feed.

The present invention also allows the user to create a page for specialized content, such as a profile page, social group page, or business page. The profile page is automatically generated for the user in the preferred embodiment of the present invention. Each page has an aggregate social feed that contains information relevant to that specific page. For example, the aggregate social feed for the page relating to the profile of the user would contain the public information posted to the plurality of social media accounts of the user, either by friends of the user or the user them self; in other words the news feed for each of the plurality of social media accounts retrieved by the server is a public news feed of the user.

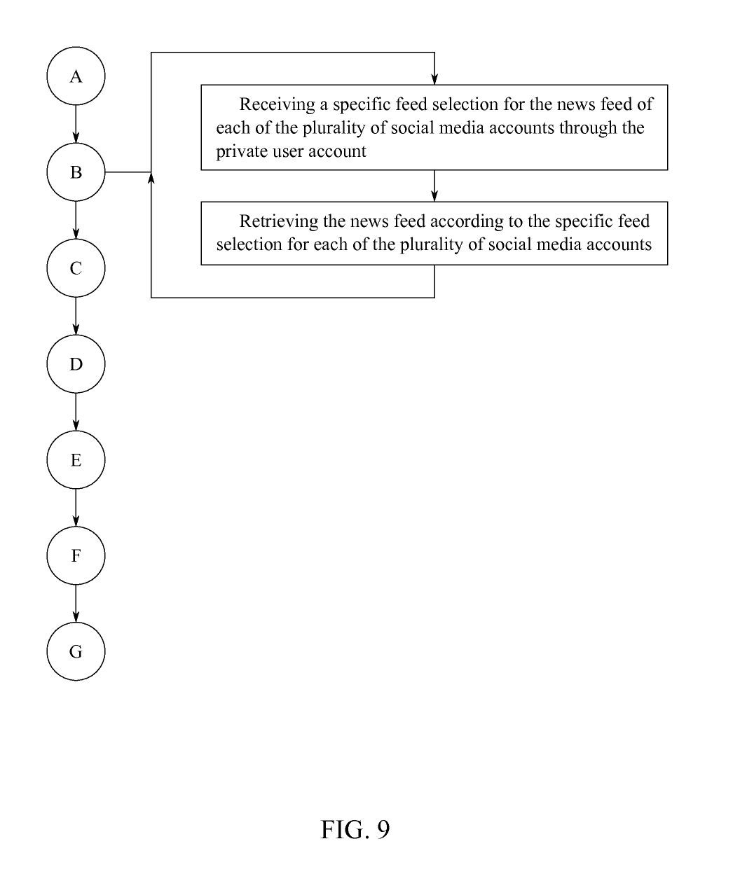

In reference to FIG. 9, for the page relating to a social group or business, the user makes a specific feed selection for the news feed of each of the plurality of social media accounts. For example, if the page is for a group about life hacks, then the specific feed selection would be for the news feed from another social media account pertaining to life hacks. The specific feed selection is submitted by the user through the private user account, and received by the server, wherein the server retrieves the news feed according to the specific feed selection for each of the plurality of social media accounts. The server then aggregates the news feed of each of the plurality of social media accounts and generates the aggregate social feed that is specific to the page.

Social content can be posted to each page in the same way the social content is posted to the plurality of social media accounts. The broadcast content scheduling module allows the user to select a specific page or pages to which the social content is to be posted. The social content can be posted to just the selected page or pages, just the selected social media accounts, or both through the broadcast content scheduling module. The user submits a page selection through the broadcast content scheduling module, wherein the server receives the page selection and posts the social content to the specific page corresponding to the page selection.

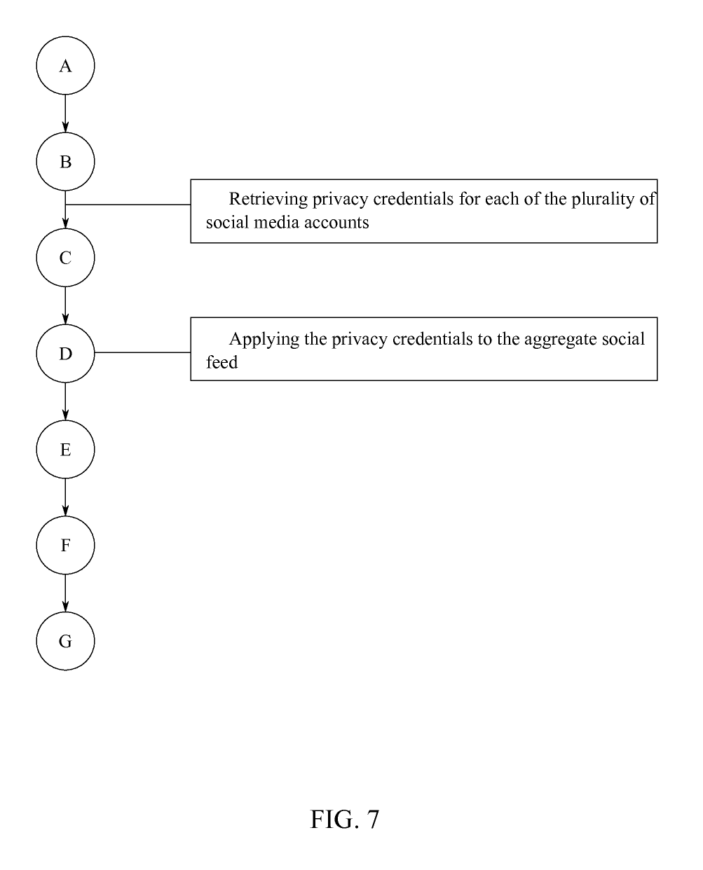

In reference to FIG. 7, in the process of generating the aggregate social feed for each page, it is also possible for the server to retrieve privacy credentials for each of the plurality of social media accounts. The server then applies the privacy credentials to the aggregate social feed, wherein the privacy credentials dictate which individuals are able to view the aggregate social feed. For example, the privacy credentials for the page of a private group could dictate that the aggregate social feed for the page is only viewable by invited members of the private group. The ability to import the privacy credentials saves the user time and keeps the visibility of information consistent across all platforms. Additional privacy settings may also be provided in order to adjust the privacy credentials within the present invention, or to negate the privacy credentials.

Each page created by the user is viewable to other public users, unless the privacy settings are configured otherwise. A public user is able to view the page created through the private user account and any advertisements that may have been enabled by the user for that page; however, the public user is not able to interact with or utilize any functions of the page other than the advertisements. The public user has not created an account, and has not logged into the website using the account information and login module; as such, the public user is afforded only the ability to observe the aggregate social feed and advertisements for the page through the website. So long as the privacy settings for the page are configured to be public, the aggregate social feed of the page is viewable by anyone who visits the page and is accessible simply by entering the Uniform Resource Locator of the website.

The public user can also create a subsequent private user account in order to interact with the page created through the private user account. When logged into the subsequent private user account, the public user can not only view the page created through the private user account, but the public user can post social content to the aggregate social feed of the page. Additionally, when logged into the subsequent private user account, the public user can access functions of the homepage dashboard for the subsequent private user account.

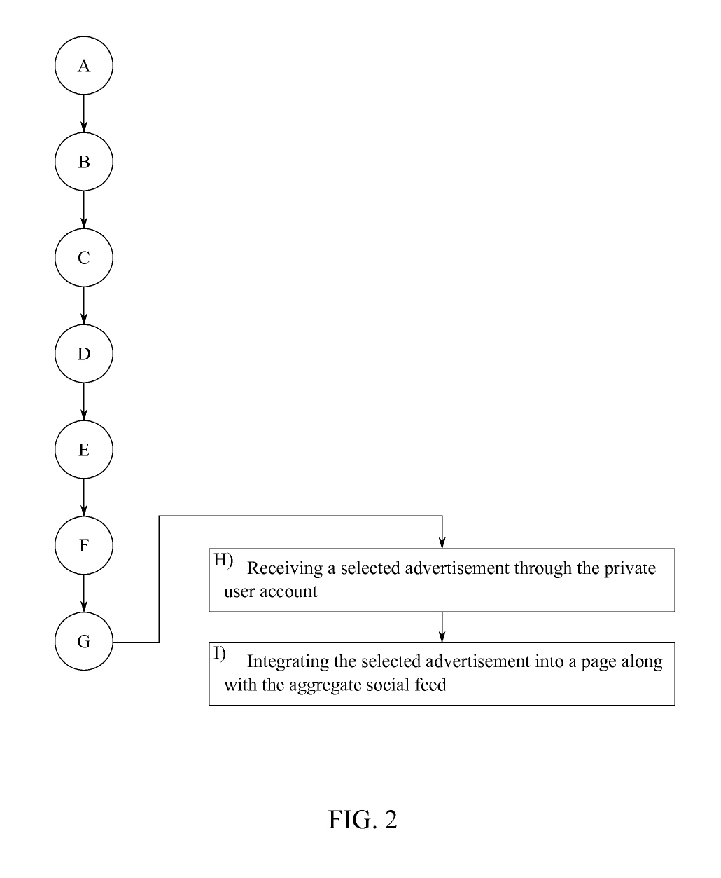

The present invention also provides an ad sharing module through which the user can monetize each page. In reference to FIG. 2, the user picks a selected advertisement through the private user account, wherein the server receives the selected advertisement and integrates the selected advertisement into the page along with the aggregate social feed. Additionally, the server displays the selected advertisement alongside the aggregate social feed on the homepage dashboard, profile or group page of the private user account. The user can either choose to create the selected advertisement or pick the selected advertisement from an advertisement marketplace. If the user picks the selected advertisement from the advertisement marketplace, then the user may have to agree to terms provided by the creator of the selected advertisement. Additionally, the user may be required to subscribe to a paid membership in order to access and use advertisements from the advertisement marketplace.

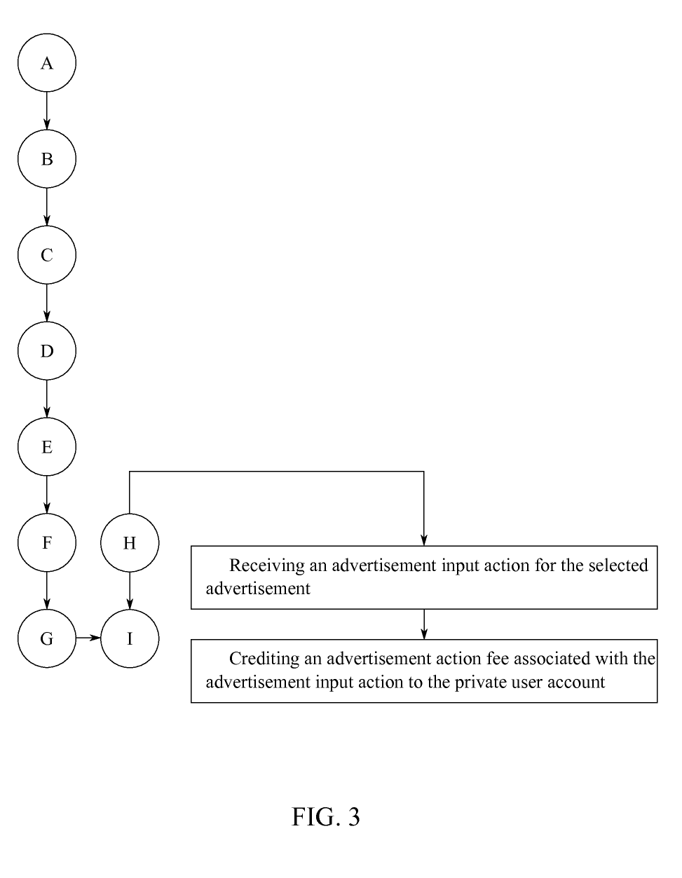

Each of the advertisements available through the advertisement marketplace can be searched by category as well as by cost per action. In reference to FIG. 3, the cost per action dictates an advertisement action fee that is credited to the private user account each time public users complete an advertisement input action associated with the selected advertisement. The server monitors the selected advertisement, and when the server receives the advertisement input action, or otherwise detects the advertisement input action, the server credits the advertisement action fee associated with the advertisement input action to the private user account.

The advertisement input action may be different for each advertisement; for some advertisements, the public user simply needs to click the selected advertisement, while for other advertisements the public user must actually purchase some product after being directed to a merchant website selling the product. The user is able to view all parameters pertaining to the selected advertisement and the advertisement input action, thereby allowing the user to make a decision about which advertisements are likely to be the most effective. This provides a unique advantage, as the user is likely to choose advertisements which the user believes friends may be interested in; thus allowing for more targeted marketing of advertisements without the need for any demographic research by advertising companies. The user is serving as a sort of middleman, using knowledge of friends' demographics and interests to distribute targeted advertisements.

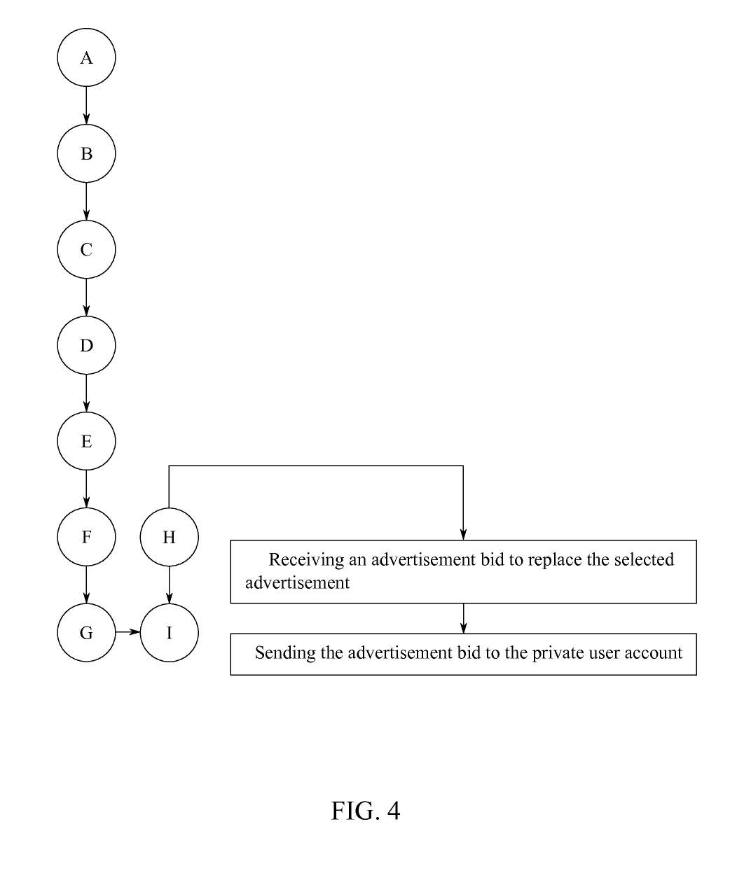

In reference to FIG. 4, the present invention also allows public users to bid on advertisement spots for each page created through the private user account. By hovering over the selected advertisement with a cursor, a pop-up appears allowing the public user to place a bid to replace the selected advertisement. The advertisement bid details the parameters of a replacement advertisement, such as the cost per action and the advertisement input action. The advertisement bid is received by the server, wherein the server then sends the advertisement bid to the private user account. The user can then view the advertisement bid and choose whether or not to replace the selected advertisement with the replacement advertisement.

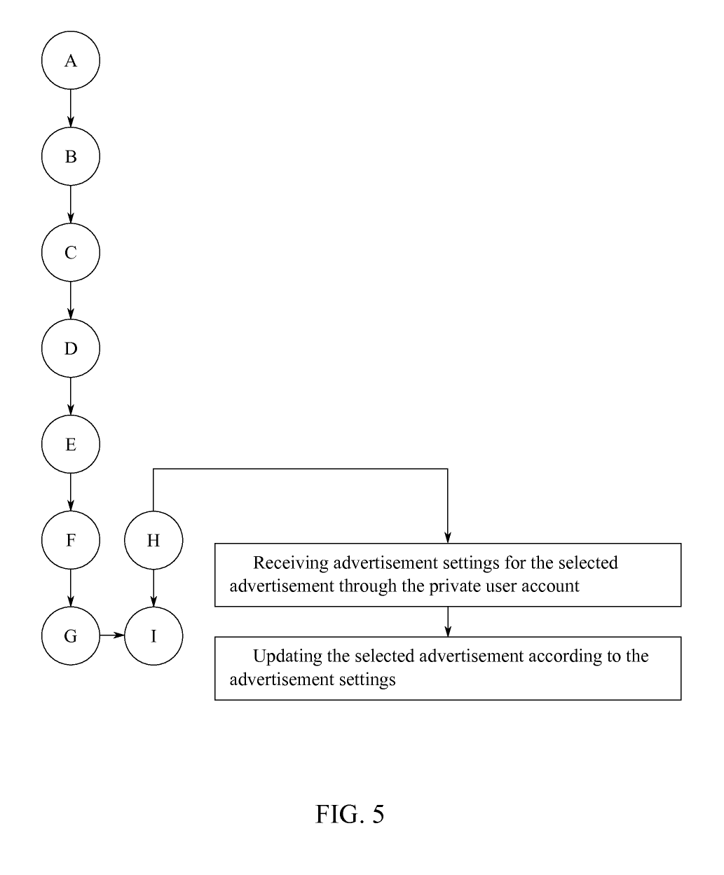

In reference to FIG. 5, if the user hovers over the selected advertisement through the private user account, then a pop-up appears allowing the user to configure advertisement settings for the selected advertisement. Through the advertisement settings the user can toggle the advertisement spot on and off, set an advertisement mode, and select a category. The advertisement mode allows the selected advertisement to be cycled through a series of advertisements, remain fixed, or be automatically chosen by best fit. The category defines the nature of the advertisements if the selected advertisement is rotated or chosen by best fit. In some embodiments of the present invention, the user may be required to subscribe to a paid membership in order to toggle the selected advertisement off.

In addition to the functions described above, the present invention also provides the user with other applications accessible through the homepage dashboard. Such other applications include, but are not limited to, a timeline, blog, and calendar. There is an extremely wide range of possibilities for the existence and purpose of said applications. Furthermore, the present invention provides a means of gamification in the form of badges. The inclusion of the badges is to encourage the user to interact and explore all functions of the present invention. The badges can be awarded to the user for tasks including, but not limited to, becoming a subscribed user, synching a certain number of social media accounts with the private user account, making a blog post, referring other users, or reaching a certain number of total posts through the website.

Although the invention has been explained in relation to its preferred embodiment, it is to be understood that many other possible modifications and variations can be made without departing from the spirit and scope of the invention as hereinafter claimed.

What is claimed is:

1. A method for providing a combination social media dashboard aggregator, social media website network, and advertisement marketplace by executing computer-executable instructions stored on a non-transitory computer-readable medium, the method comprises the steps of:
synching a private user account operated through an electronic device to a plurality of social media accounts;
retrieving a news feed from each of the social media accounts;
generating a social tab for the news feed of each of the plurality of social media accounts, wherein the social tab is accessible through the private user account;
aggregating the news feed from each of the plurality of social media accounts into an aggregate social feed;
receiving social content through the private user account;
receiving selected social media accounts from the plurality of social media accounts through the private user account; and
sending the social content to the selected social media accounts, wherein the social content is displayed through the selected social media accounts.

2. The method for providing a combination social media dashboard aggregator, social media website network, and advertisement marketplace by executing computer-executable instructions stored on a non-transitory computer readable medium, the method as claimed in claim 1 further comprises the steps of:
receiving a selected advertisement through the private user account; and
integrating the selected advertisement into a page along with the aggregate social feed.

3. The method for providing a combination social media dashboard aggregator, social media website network, and advertisement marketplace by executing computer-executable instructions stored on a non-transitory computer readable medium, the method as claimed in claim 2 further comprises the steps of:
receiving an advertisement input action for the selected advertisement; and
crediting an advertisement action fee associated with the advertisement input action to the private user account.

4. The method for providing a combination social media dashboard aggregator, social media website network, and advertisement marketplace by executing computer-executable instructions stored on a non-transitory computer-readable medium, the method as claimed in claim 2 further comprises the steps of:
receiving an advertisement bid to replace the selected advertisement; and
sending the advertisement bid to the private user account.

5. The method for providing a combination social media dashboard aggregator, social media website network, and advertisement marketplace by executing computer-executable instructions stored on a non-transitory computer-readable medium, the method as claimed in claim 2 further comprises the steps of:
receiving advertisement settings for the selected advertisement through the private user account; and
updating the selected advertisement according to the advertisement settings.

6. The method for providing a combination social media dashboard aggregator, social media website network, and advertisement marketplace by executing computer-executable instructions stored on a non-transitory computer readable medium, the method as claimed in claim 1 further comprises the steps of:
receiving login credentials for each of the plurality of social media accounts through the private user account.

7. The method for providing a combination social media dashboard aggregator, social media website network, and advertisement marketplace by executing computer-executable instructions stored on a non-transitory computer readable medium, the method as claimed in claim 1 further comprises the steps of:
retrieving privacy credentials for each of the plurality of social media accounts; and
applying the privacy credentials to the aggregate social feed.

8. The method for providing a combination social media dashboard aggregator, social media website network, and advertisement marketplace by executing computer-executable instructions stored on a non-transitory computer readable medium, the method as claimed in claim 1 further comprises the steps of:
receiving distribution parameters for the social content through the private user account; and
generating a content schedule for distributing the social content according to the distribution parameters.

9. The method for providing a combination social media dashboard aggregator, social media website network, and advertisement marketplace by executing computer-executable instructions stored on a non-transitory computer readable medium, the method as claimed in claim 1 further comprises the steps of:
receiving a specific feed selection for the news feed of each of the plurality of social media accounts through the private user account; and
retrieving the news feed according to the specific feed selection for each of the plurality of social media accounts.

10. The method for providing a combination social media dashboard aggregator, social media website network, and advertisement marketplace by executing computer-executable instructions stored on a non-transitory computer-readable medium, the method as claimed in claim 1 further comprises the steps of:
receiving a filter selection through the private user account; and
applying the filter selection to the aggregation of the aggregate social feed.

11. The method for providing a combination social media dashboard aggregator, social media website network, and advertisement marketplace by executing computer-executable instructions stored on a non-transitory computer-readable medium, the method as claimed in claim 1 further comprises the steps of:
receiving a feed update frequency through the private user account; and
applying the feed update frequency to the aggregation of the aggregate social feed.

12. A method for providing a combination social media dashboard aggregator, social media website network, and advertisement marketplace by executing computer-executable instructions stored on a non-transitory computer-readable medium, the method comprises the steps of:
synching a private user account operated through an electronic device to a plurality of social media accounts;
retrieving a news feed from each of the social media accounts;
generating a social tab for the news feed of each of the plurality of social media accounts, wherein the social tab is accessible through the private user account;
aggregating the news feed from each of the plurality of social media accounts into an aggregate social feed;
receiving social content through the private user account;
receiving selected social media accounts from the plurality of social media accounts through the private user account;
receiving distribution parameters for the social content through the private user account;
generating a content schedule for distributing the social content according to the distribution parameters;
sending the social content to the selected social media accounts, wherein the social content is displayed through the selected social media accounts;
receiving a selected advertisement through the private user account; and
integrating the selected advertisement into a page along with the aggregate social feed.

13. The method for providing a combination social media dashboard aggregator, social media website network, and advertisement marketplace by executing computer-executable instructions stored on a non-transitory computer readable medium, the method as claimed in claim 12 further comprises the steps of:
receiving an advertisement input action for the selected advertisement; and
crediting an advertisement action fee associated with the advertisement input action to the private user account.

14. The method for providing a combination social media dashboard aggregator, social media website network, and advertisement marketplace by executing computer-executable instructions stored on a non-transitory computer-readable medium, the method as claimed in claim 12 further comprises the steps of:
receiving an advertisement bid to replace the selected advertisement; and
sending the advertisement bid to the private user account.

15. The method for providing a combination social media dashboard aggregator, social media website network, and advertisement marketplace by executing computer-executable instructions stored on a non-transitory computer-readable medium, the method as claimed in claim 12 further comprises the steps of:
receiving advertisement settings for the selected advertisement through the private user account; and
updating the selected advertisement according to the advertisement settings.

16. The method for providing a combination social media dashboard aggregator, social media website network, and advertisement marketplace by executing computer-executable instructions stored on a non-transitory computer readable medium, the method as claimed in claim 12 further comprises the steps of:
receiving login credentials for each of the plurality of social media accounts through the private user account.

17. The method for providing a combination social media dashboard aggregator, social media website network, and advertisement marketplace by executing computer-executable instructions stored on a non-transitory computer readable medium, the method as claimed in claim 12 further comprises the steps of:
retrieving privacy credentials for each of the plurality of social media accounts; and
applying the privacy credentials to the aggregate social feed.

18. The method for providing a combination social media dashboard aggregator, social media website network, and advertisement marketplace by executing computer-executable instructions stored on a non-transitory computer readable medium, the method as claimed in claim 12 further comprises the steps of:
receiving a specific feed selection for the news feed of each of the plurality of social media accounts through the private user account; and
retrieving the news feed according to the specific feed selection for each of the plurality of social media accounts.

19. The method for providing a combination social media dashboard aggregator, social media website network, and advertisement marketplace by executing computer-executable instructions stored on a non-transitory computer-readable medium, the method as claimed in claim 12 further comprises the steps of:
receiving a filter selection through the private user account; and
applying the filter selection to the aggregation of the aggregate social feed.

20. The method for providing a combination social media dashboard aggregator, social media website network, and advertisement marketplace by executing computer-executable instructions stored on a non-transitory computer-readable medium, the method as claimed in claim 12 further comprises the steps of:
receiving a feed update frequency through the private user account; and
applying the feed update frequency to the aggregation of the aggregate social feed.
